(19) United States
(12) Patent Application Publication
(10) Pub. No.: US 2008/0263213 A1
(43) Pub. Date: Oct. 23, 2008

(54) COMMUNICATION DEVICE AND CLIENT DEVICE

(76) Inventor: Masafumi Kinoshita, Sagamihara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/061,942

(22) Filed: Apr. 3, 2008

(30) Foreign Application Priority Data
Apr. 19, 2007 (JP) 2007-110467

(51) Int. Cl. G06F 15/173

(52) U.S. Cl. 709/228

(57) ABSTRACT

Relaying devices to share workload among them are disposed in the carrier equipment network. The relaying devices respectively relay an HTTP message between the mobile phone and the web server and store an upload data from the mobile phone. The relaying devices respectively transmit to the mobile phone, before or immediately after uploading data, an address to couple the mobile phone to them and an identifier to specify an upload data. Where line disconnection has occurred between the mobile phone and the relaying device, the mobile phone resumes coupling to the address of the relaying device in question and transmits the identifier thereto. The relaying devices respectively search data corresponding to the identifier and transmit a data size as stored therein to the mobile phone. The mobile phone transmits data that the respective relaying devices have not stored to each of them.

### INCORPORATION BY REFERENCE

The present application claims priority from Japanese patent application serial no. 2007-110467, filed on Apr. 19, 2007, the content of which is hereby incorporated by reference into this application.

### BACKGROUND OF THE INVENTION

The present invention relates to a client device to upload data through a network and to receive an upload data.

The web access from mobile phones has recently increased to a great degree, in accordance with which the web applications by way of mobile phones have increased. Correspondingly, the data volume among mobile phones and servers has augmented. Likewise, the time required for transmitting and receiving data, or that during which the lines among such phones and servers are maintained, has been extended. Wireless networks, carrier equipment networks and the Internet intervene between such phones and web servers. The wireless networks are vulnerable to temporary communication failure according to the portability of such phones. In turn, the carrier equipment networks cope with such case by disconnecting lines through which communication has not been established for a certain time. This line disconnection has caused the data stored in such phones by the time when such disconnection has occurred to be lost and communication with a server to be afresh established in order to obtain such lost data, which series of communication processing by way of mobile phones is hereinafter referred to as ‘a retry processing’. Furthermore, with such session cut-off frequently occurred, the retry processing makes the data volume to be handled in wireless and carrier equipment networks, the Internet and servers suddenly increase. As a result of it, it gives an enormous workload to the communication system so as to be likely to cause problems therein.

In order to solve the prior issue as mentioned above, such method is disclosed in Japanese Patent Application Laid-open No. 2001-231080 (hereinafter, referred to as Document 1) as restraining the data from being retransmitted from the server to the mobile phone subsequent to line disconnection. Therein, a relaying device, in which the communication data from servers is stored and managed, is provided in carrier equipment networks or the Internet among the mobile phones and servers, which relaying device acts as replacement for such phones and stores such data when the lines among such phones and servers are disconnected. Then, the mobile phones obtain such data as stored in the relaying device so as to dispense with such retry processing.

### SUMMARY OF THE INVENTION

The method according to Document 1 is characterized to dispense with such retry processing involved with data transmission from servers to mobile phones (or downloading) However, the data volume transmitted from the mobile phones to servers (hereinafter, referred to as ‘uploading’) has recently increased to a great extent. Where the lines among such phones and servers have been disconnected during uploading operation, the method according to Document 1 cannot cope with resuming uploading data subsequently from that having been transmitted by the time when they are disconnected, as the mobile phones are incapable of obtaining a size of the upload data actually received in the relaying device. In turn, even if the mobile phones might have such function as storing such size as actually uploaded to the relaying device before disconnection and resuming uploading the remaining data subsequently from that having been transmitted by that time, it may be impossible to realize the resumption of uploading the data, since that might be lost in wireless or carrier equipment network.

With the method disclosed in Document 1, adopting the relaying devices for such workload sharing system as carrier equipment network, the mobile terminals are incapable of accessing the same relaying device all the time.

In view of the foregoing, the invention is to provide a system to enable the uploading of data from mobile phones to servers to be resumed, where the lines among such phones and servers are disconnected during such uploading.

The above prior issues are solved by means of a communication device provided with a processor, a memory storage and an input and output interface that are coupled through an internal communication line, wherein the processor executes a program stored in the memory storage, wherein the input and output interface is coupled to a client device through a first network, and wherein the processor acts as a memory controller to store into the memory storage an upload request together with a communication identifier upon receiving the upload request from the client device while to store an upload data into the memory storage upon receiving the upload data from the client device and as a transmission controller to transmit to the client device the communication identifier along with an address of the communication device in response to the upload request while to transmit to the client device the communication identifier together with a size of the upload data as stored in the memory storage in response to a resumed coupling request from the client device upon receiving the resumed coupling request therefrom.

Further, the above prior issues are solved by means of a communication device provided with a processor, a memory storage and an input and output interface that are coupled through an internal communication line, wherein the processor executes a program stored in the memory storage, wherein the input and output interface is coupled to a client device through a first network, and wherein the processor acts as a memory controller to store into the memory storage an upload request together with a communication identifier upon receiving the upload request from the client device while to store an upload data into the memory storage upon receiving the upload data from the client device and as a transmission controller to transmit to the client device the communication identifier, a size of the upload data as stored in the memory storage together with an address of the communication device upon detecting that a line is disconnected from the client device.

Moreover, the above prior issues are solved by means of a client device provided with a processor, a memory storage, an input and output interface, a picture output interface and an input interface that are coupled through an internal communication line, wherein the processor executes a program stored in the memory storage, wherein the input and output interface is coupled to a communication device through a network, and wherein the processor acts as a memory controller to store in the memory storage a communication identifier and an address of the communication device as contained in a response against an upload request transmitted to the communication device and as a transmission controller to transmit to the address a resumed coupling request containing the communication identifier upon an uploading operation to the communication device being suspended.

These and other benefits are described throughout the present specification. A further understanding of the nature and advantages of the invention may be realized by reference to the remaining portions of the specification and the attached drawings.

### BRIEF DESCRIPTION OF THE DRAWINGS

Preferred embodiments of the present invention will now be described in conjunction with the accompanying drawings, in which;

FIG. 1 shows an exemplary block diagram of the network system;

FIG. 2 shows an exemplary block diagram of the mobile phone hardware;

FIG. 3 shows an exemplary block diagram of the relaying device hardware;

FIG. 4 is an explanatory view to show an example of the receiving control table;

FIG. 5 shows one example of a message format of the upload request;

FIG. 6 shows one example of a message format of the continued response;

FIG. 7 shows one example of a message format of the resumed coupling request;

FIG. 8 shows one example of a message format of the resumed upload information;

FIG. 9 is an explanatory view to show one example of a picture output when the mobile phone retries;

FIG. 10 shows one example of the sequential uploading steps among the mobile phone, the relaying device and the web server;

FIG. 11 is a flow chart to show one example of the uploading operation by the mobile phone;

FIG. 12A is a first flow chart to show one example of the uploading steps by the relaying device;

FIG. 12B is a second flow chart to show one example of the uploading steps by the relaying device;

FIG. 13 shows one example of a segmentally transmitted upload request message format;

FIG. 14 shows one example of a segmentally transmitted upload data format;

FIG. 15 shows one example of a network system hardware block diagram;

FIG. 16 shows one example of a web server hardware block diagram;

FIG. 17 shows one example of a message format for a continued response;

FIG. 18 shows one example of the data uploading sequential steps between the mobile phone and the web server;

FIG. 19 shows one example of a response message format against a GET request;

FIG. 20 shows one example of the data uploading sequential steps between the mobile phone and the web server;

FIG. 21 shows one example of the network system block diagram; and

FIG. 22 shows one example of the data uploading sequential steps among the mobile phone, the relaying device, the web server and the Short message Service Center (hereinafter, referred to as ‘message center’).

### DETAILED DESCRIPTION OF THE EMBODIMENTS

Hereafter, preferred embodiments of the invention are described with reference to the accompanying drawings, in which the same reference numbers are used for substantially identical parts to avoid redundancy of the explanation.

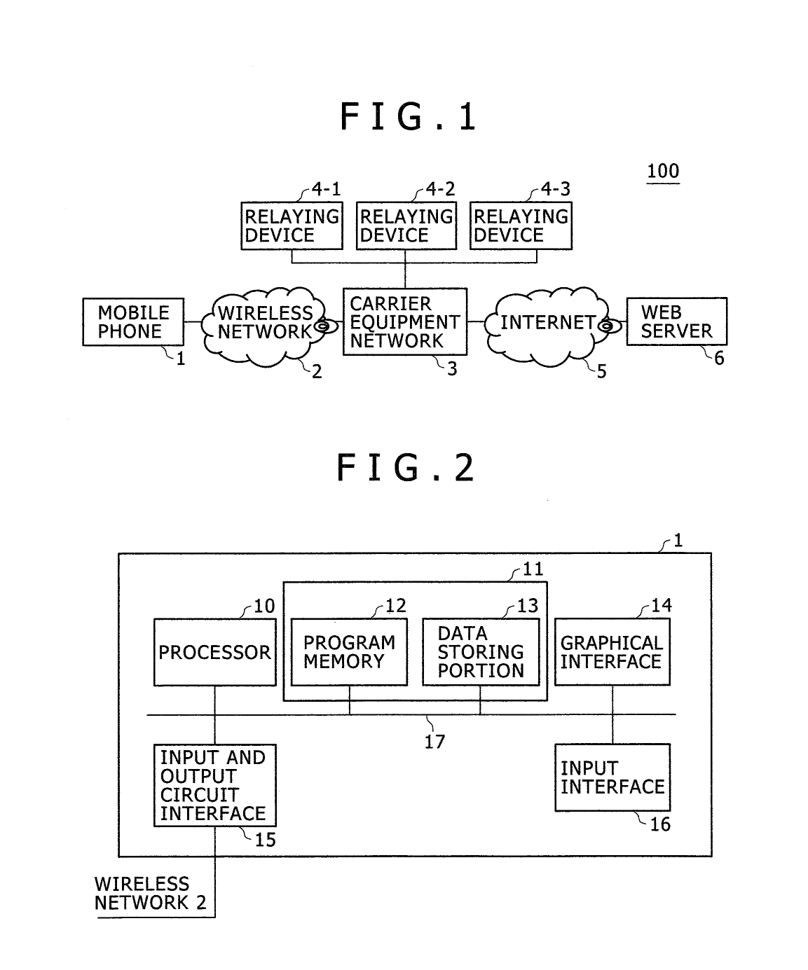

The first embodiment is explained with reference to FIGS. 1 to 12. A network system is explained according to FIG. 1. It shows a block diagram of such system. Therein, the network system 100 includes a carrier equipment network 3 and a mobile phone 1 respectively direct-coupled to a wireless network 2, the Internet 5 and a web server 6 respectively and three relaying devices 4 respectively direct-coupled to the carrier equipment network 3.

The relaying devices 4 respectively have such functions as relaying an HTTP request from the mobile phone 1 to the web server 6 through the Internet 5, which is referred herein to as ‘proxy function’, and as storing the relayed data and making up a message containing information (hereinafter, referred to as ‘resumption information’) to make the phone 1 access to those devices themselves. There are plurality of relaying devices 4 with workload shared among one another within the carrier equipment network 3, which devices respectively have an identifiable IP address (hereinafter, referred to as ‘relaying device address’) to discern each of them. To note, the relaying device address may well be an identifier such as an identifiable host name to identifiably discern the respective relaying devices 4-1 through 4-3.

The mobile phone 1 is a portable communication terminal to communicate data through the wireless and carrier equipment networks 2 and 3, and has such functions as transmitting and receiving data through a communication line among the wireless network 2, the carrier equipment network 3 and the Internet 5 and as making HTTP communication feasible as well as enabling itself to be resumed coupling to the relaying device 4 by way of the resumption information received from the relaying device 4 even upon line disconnection having occurred on the wireless and carrier equipment networks 2 and 3.

The wireless network 2 is managed by a portable carrier entity. The carrier equipment network 3 is intended for convertibly relaying communication from the wireless network 2 to the Internet 5.

The web server 6 has such function as carrying out the HTTP communication with the mobile phone 1, which server may operate in engagement with a DB server or another web server.

With reference to FIG. 2, a hardware arrangement of the information processing device to realize the mobile phone is set forth below. FIG. 2 shows a hardware block diagram of the mobile phone. As shown, the mobile phone 1 includes a processor 10, a memory storage 11, a picture output interface 14 such as a display, an input and output circuit interface 15 to transmit data to a wireless network 2 and receive it therein, an input interface 16 to input data and an internal communication line 17 such as a bus to couple those elements. The memory storage 11 stores a program memory 12 and a data storing portion 13. Various kinds of control programs are recorded in the program memory 12 to realize the mobile phone 1, which memory 12 is executed by the processor 10. To note, the respective programs may be preliminarily stored in the program memory 12 or be introduced into the same through a detachable storage medium or a communication medium (network or carrier wave propagating the same) not shown in the drawing The program memory 12 consists of a program by which the mobile phone 1 realizes HTTP communication with the web server 6 and that by which uploading operation is resumed through the relaying device 4 upon line disconnection having occurred during such operation. Those programs may be of the same type or the latter program (such program as realized by Java, JavaScript, Flash and so forth) may be obtained for operation through a network with the former program realizing HTTP communication in use. In the data storing portion 13 within the memory storage 11, the resumption information obtained from the relaying device 4 during uploading operation and information obtained through communication with the web server 6 are stored. The memory storage 11 is a semiconductor storage or an external storage such as a hard disk. The graphical interface 14 is a means by which a user of the mobile phone 1 displays communication contents with the web server 6 and data as stored in the memory storage 11. The input interface 16 is a means enabling the user to input data therein.

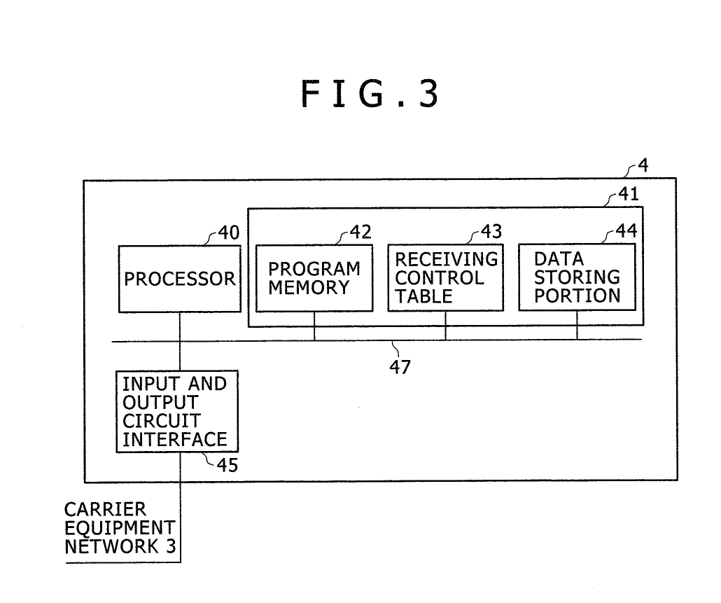

With reference to FIG. 3, a hardware arrangement of the information processing device to realize the relaying device is explained below. FIG. 3 shows a hardware block diagram of the relaying device. As shown, the relaying device 4 includes a processor 40, a memory storage 41, an input and output circuit interface 45 to transmit data to a carrier equipment network 3 and receive the same therein and an internal communication line 47 such as a bus to couple those elements. The memory storage 41 stores a program memory 42, a receiving control table 43 and a data storing portion 44. In the program memory 42, various kinds of control programs to realize the relaying device 4 are recorded, which memory 42 is executed by the processor 40. To note, the respective programs may be preliminarily stored in the program memory 42 or introduced into the same through a detachable storage medium or communication medium (network or carrier wave propagating the same) not shown in the drawing. In the receiving control table 43, such information as for controlling upload requests and data that the relaying device 4 has received from the mobile phone 1 is described. The receiving control table 43 may be compiled upon the relaying device 4 relaying an upload request from the mobile phone 1 or obtained by the relaying device 4 from a storage medium provided with such table of other than the relaying device 4 through a communication medium (network or carrier wave propagating the same). In the data storing portion 44, such information is stored as the relaying device 4 having obtained when relaying an HTTP message of the web server 6 to the mobile phone 1 and as used for resumption of uploading operation subsequent to line disconnection between the mobile phone 1 and the relaying device 4. The memory storage 41 is a semiconductor storage or an external memory storage such as a hard disk. The relaying device 4 is provided with an input device and a display enabling a system administrator to input data. However, those means are not put to use in the following explanation so that they are omitted in FIG. 3. To note, FIG. 1 shows the relaying device 4 installed in the carrier equipment network 3, which device may well be installed in the Internet 5.

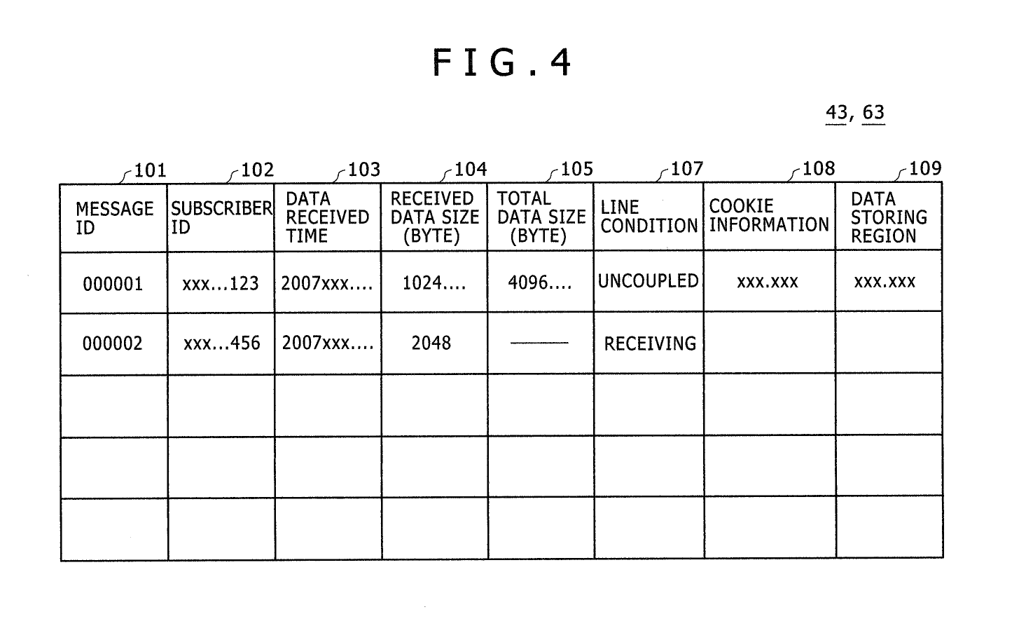

With reference to FIG. 4, the receiving control table is explained as follows. FIG. 4 is an explanatory view of such table. As shown, the respective entries of the receiving control table 43 comprise a message ID 101, a subscreiber ID 102, a data received time 103, a received data size 104, a total data size 105, the last data received time 107, a piece of Cookie information 108 and a data storing region 109.

The message ID 101 is an identifier to identifiably discern an upload request and an upload data that the relaying device 4 has received from the mobile phone 1 and stored therein. The subscreiber ID 102 is an identifier to identifiably distinguish the mobile phone 1. The data received time 103 is that when the relaying device 4 has begun receiving an upload request from the mobile phone 1. The relaying device 4 erases the upload request and data stored therein after a predetermined time has lapsed from the time 103. The received data size 104 is that of what the relaying device 4 has received from the mobile phone 1. The total data size 105 is that of the total data that the mobile phone 1 is about to upload, which data size the relaying device 4 gets out of a header of an upload request. However, the total data size 105 is of no use, as there is no total data size within the header of such request, where the mobile phone 1 segmentally transmits data.

The last data received time 107 is that when the relaying device 4 has received the upload data from the mobile phone 1 last of all, which time is used for confirming whether or not the line between the relaying device 4 and the mobile phone 1 exists and erasing the upload data as stored after a predetermined time has lapsed from the time 107. The Cookie information 108 is used particularly when the Cookie is in use on HTTP communication between the mobile phone 1 and the web server 6 through the relaying device 4 and the Cookie information must be altered by the relaying device 4 upon uploading operation being resumed subsequent to line disconnection. The data storing region 109 indicates in which part of the data storing portion 44 of the relaying device 4 the upload data exists.

To note, when the mobile phone 1 segmentally transmits data by use of ‘Transfer-Encoding: chunked’ in compliance with HTTP 1.1, the identifier of the message ID 101 is defined as ‘000002’, which indicates that the total data size 105 is of no use.

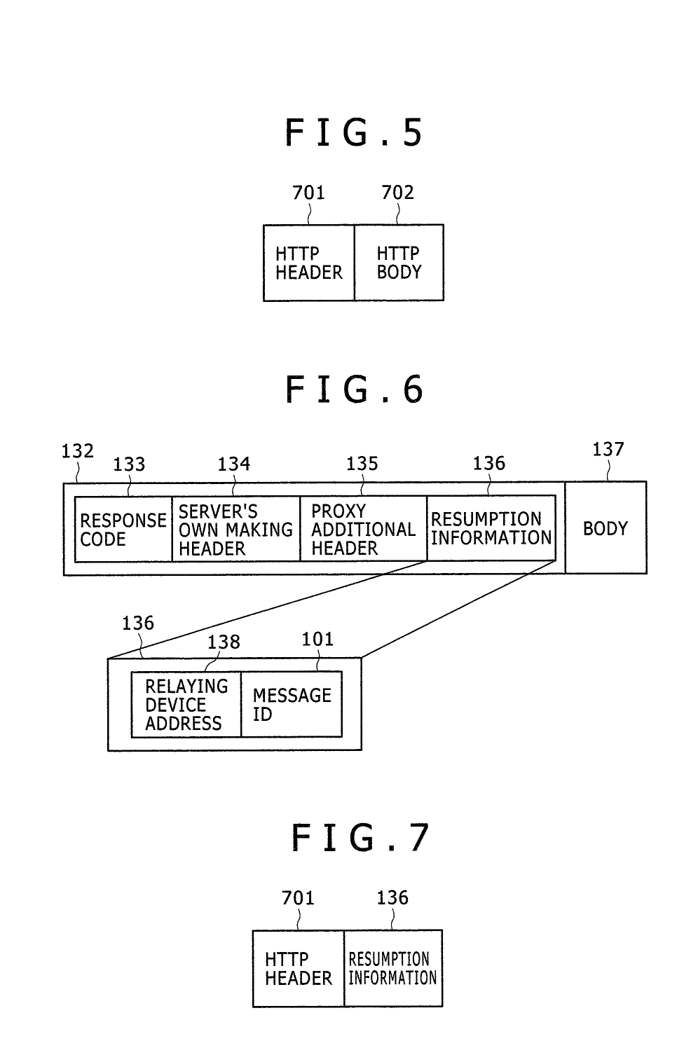

With reference to FIG. 5, an upload request transmitted to the relaying device from the mobile phone is explained as follows. FIG. 5 shows a message format for such request. As shown, it includes an HTTP header 701 and an HTTP body 702. Concretely speaking, a POST method in compliance with HTTP is described in a request line of the HTTP header, and a portion of the upload data is contained in the HTTP body 702 for transmission. To note, the HTTP body 702 may well be done without.

With reference to FIG. 6, an HTTP response with resumption information added thereto that is transmitted to the mobile phone from the relaying device is explained as follows. FIG. 6 shows a message format for a continued response. What the continued response stands for herein is that by a response code 100 in compliance with HTTP that is sent from the web server. As shown, the continued response is such data as the relaying device 4 having added resumption information to a response by the web server 6 against the upload request by the mobile phone 1. The continued response includes a header 132 and a body 137, in which the header 132 includes a response code 133 made up by the web server 6 and the server's own making header 134, a proxy additional header 135 added by the relaying device 4 and a piece of resumption information 136.

The response code 133 is a resulting code by three digits from the upload request, which code is represented with ‘100’ for the continued response. The server's own making header 134 is a piece of header information other than the response code 133 of the web server 6's own making. The proxy additional header 135 is that added as a proxy function by the relaying device 4, which header corresponds to a Via header, for example, showing that the continued response is relayed. The resumption information 136 is that for resuming coupling of the mobile phone 1 to the relaying device 4 when the mobile phone 1 is being uncoupled. The resumption information includes a relaying device address 138 and a message ID 101. To note, the resumption information 136 is stored in the header 132, but may well be stored in the body 137.

With reference to FIG. 7, a resumed coupling request transmitted to the relaying device from the mobile phone is explained as follows. FIG. 7 shows a message format for such request. As shown, it includes an HTTP header 711 and a piece of resumption information 136 as recorded in an HTTP body, which information the mobile phone 1 has received from the relaying device 4 through the continued response. In such request, an address of the specific relaying device 4 that has transmitted the continued response is contained, so that such resumed coupling request is received by that specific relaying device 4.

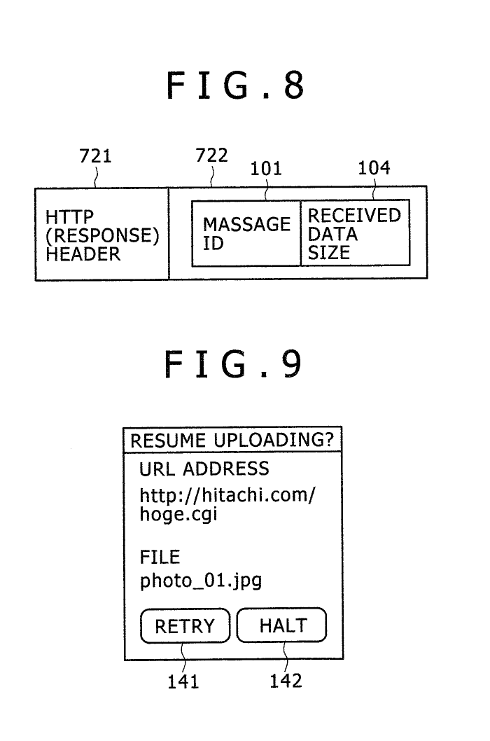

With reference to FIG. 8, a piece of upload information transmitted to the mobile phone 1 by the relaying device is explained as follows. FIG. 8 shows a message format of the resumed upload information. As shown, the resumed upload information includes an HTTP (response) header 721 and an HTTP body 722, in which the HTTP body 722 contains a message ID 101 and a size 104 of the upload data as having been received by then by the relaying device 4. The mobile phone 1 that has received the resumed upload information, by use of the message ID 101 and the data size 104, is able to transmit an upload data not received yet by the relaying device.

With reference to FIG. 9, a picture output produced upon the mobile phone retrying to resume uploading is explained as follows. FIG. 9 is an explanatory view showing a picture output produced upon the mobile phone retrying to resume uploading. As shown, the mobile phone 1 memorizes that the upload to the web server 6 has failed and outputs a picture to make the user choose whether or not to resume the upload request as suspended to a graphical interface 14. The user may resume uploading by choosing a retry button 141 by use of an input interface 16 while may halt uploading by choosing a halt button 142. To note, the retry button 141 and halt button 142 may not be necessarily of picture output, but may well be incorporated in the mobile phone 1 as the input interface 16.

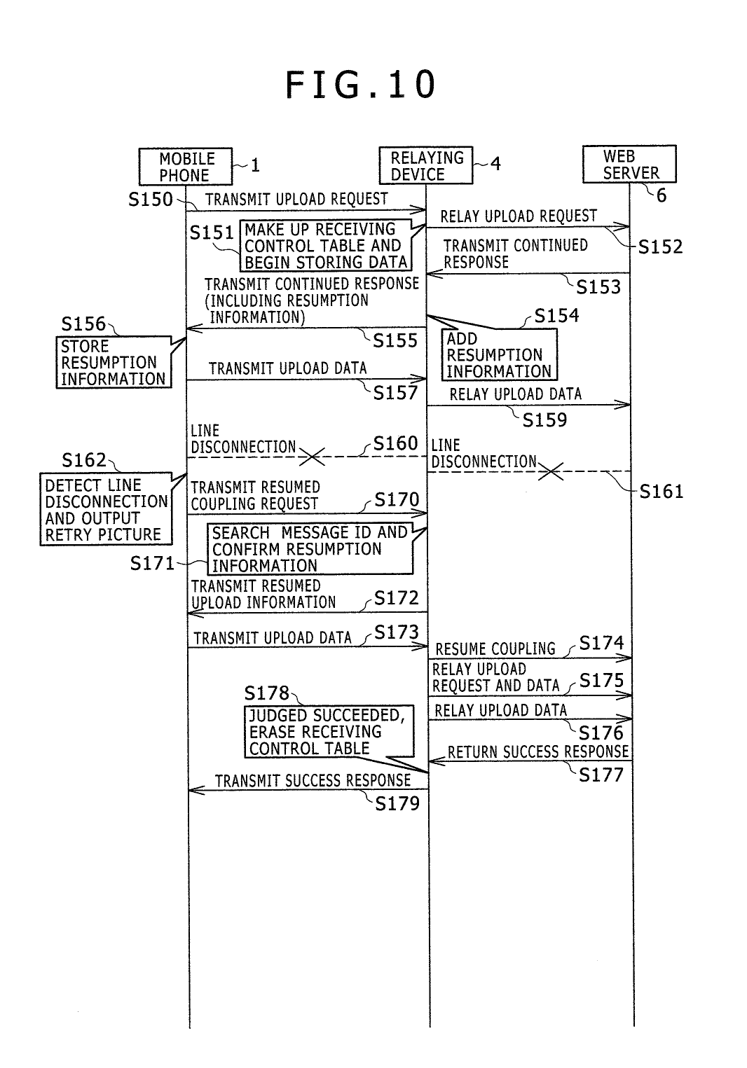

With reference to FIG. 10, the upload sequential process among the mobile phone, the relaying device and the web server is explained as follows. FIG. 10 shows the upload sequential process among the mobile phone, the relaying device and the web server. As shown, in the first place, the mobile phone 1 transmits an upload request to the web server 6 at S150. Actually, any one of the plurality of relaying devices 4 receives and analyzes such request, and stores a SUBSCREIBER ID and a total data size contained in the HTTP header of such request if it satisfies conditions (hereinafter, referred to as ‘upload process judge conditions’) so as to make up the receiving control table 43 and begin storing the upload request and data at S151. The upload process judge conditions are grounds for judging whether the relaying device 4 stores the upload request or relays such request as a normal proxy without taking any further step (hereinafter, referred to as ‘normal proxy relay process’), which grounds hereby present a case where the upload data size goes beyond a predetermined value or must be only a specific SUBSCREIBER ID or a specific URL.

The relaying device 4 relays the upload request to the web server 6 at S152 and receives a response by the response code 100 in compliance with HTTP (hereinafter, referred to as ‘continued response’) from the web server 6 at S153. The continued response is such response as indicating that the web server 6 is able to receive the upload data, which hereby corresponds to the response by the response code 100, but may well be of other equivalent response. The relaying device 4 adds a proxy additional header 135 and a piece of resumption information 136 to the continued response as received at S154 so as to transmit the continued response with such addition, the details of which are shown in FIG. 6, to the mobile phone 1 at S155. However, because there might be some among the web servers 6 that do not return a continued response, the relaying device 4 by itself makes up a continued response so as to transmit the same to the mobile phone 1, where the relaying device 4 cannot receive such response from the web server.

The mobile phone 1 stores a piece of resumption information 136 contained in the continued response and continues uploading the upload data at S157. The relaying device 4 stores the upload data and relays such data to the web server 6 at S159. The relaying device 4 may relay the upload data to the web server 6 either after having received the total size thereof or each time it receives such data.

It is supposed that the line disconnection between the mobile phone 1 and the relaying device 4 has occurred at S160. Because of ceased data transfer, the timeout causes the line between the relaying device 4 and the web server 6 to be cut off at S161.

The mobile phone 1 detects such line disconnection so as to suspend uploading and outputs a picture for retry to the picture output interface 16 at S162. The user of the mobile phone may choose whether or not to retry uploading on the picture, and it is assumed hereby that the user has chosen to retry. The mobile phone 1 transmits a resumed coupling request to the relaying device 4 at S170. The mobile phone 1 uses a relaying device address 138 and a message ID 101 contained in a piece of resumption information 136 when resuming coupling to the relaying device. The resumed coupling request is received by the relaying device 4 that has transmitted a continued response. The relaying device 4 that has received such request, by use of the message ID 101 contained in such request, extracts and confirms items corresponding to a receiving control table 43 at S171. The relaying device 4 transmits a response in compliance with HTTP containing information on the received data size 104 of the receiving control table 43 (hereinafter, referred to as ‘resumed upload information’) to the mobile phone 1 at S172 The mobile phone 1 confirms the size of the upload data that the relaying device 4 has received up to line disconnection at S160 based on the received data size 104 contained in the resumed upload information as received and transmits data that the relaying device 4 has not received yet as an upload data at S173. Upon the mobile phone 1 resumes uploading, the relaying device 4 resumes coupling to the web server 6 at S174 The relaying device 4 transmits an upload request and data to the web server 6 at S175. The upload data at S175 corresponds to that having been stored prior to line disconnection. The relaying device 4 transmits the upload request and data together with a piece of Cookie information 108 if any in the receiving control table 43. To note, upon the web server 6 receiving the upload request and data at S175, it returns a continued response, which step is hereby omitted to facilitate a series of steps.

The relaying device 4, upon receiving a new upload data at S173, transmits the same to the web server 6 at S176. Upon the whole upload data being transmitted from the mobile phone 1 to the web server 6, the latter returns a success response at S177. The relaying device 4, upon receiving the success response 177, judges that the uploading operation has succeeded so as to erase the corresponding items of the receiving control table 43 and the stored data at S178 and transmit the success response to the mobile phone 1 at S179. Upon receiving such response, the mobile phone 1 judges that the uploading operation has succeeded so as to finish the uploading procedures.

To note, the line disconnection at S161 between the relaying device 4 and the web server 6 is due to the timeout of any one of them. However, the relaying device 4 may disconnect itself from the web server 6 by detecting line disconnection at S160 from the mobile phone 1. Where there is no timeout of either of them, the steps 174 and 175 are unnecessary.

To note, FIG. 10 shows the resumption information 136 communicated from the relaying device 4 to the mobile phone 1 by use of the continued response 155 between them, but such negotiation may be made between the mobile phone and the relaying device as a request indicating the resumption of the uploading operation being transmitted from the mobile phone 1 to the relaying device 4 prior to the upload request 150 being transmitted and the relaying device 4 accepting such uploading resumption request. Then, a message exchanged between the relaying device 4 and the mobile phone 1 is in compliance with HTTP. Where the relaying device 4 accepts such negotiation initiating from the mobile phone 1, the relaying device 4 transmits a response (as explained also in FIG. 6), in which body 137 the resumption information 136 is stored, instead of the continued response 155.

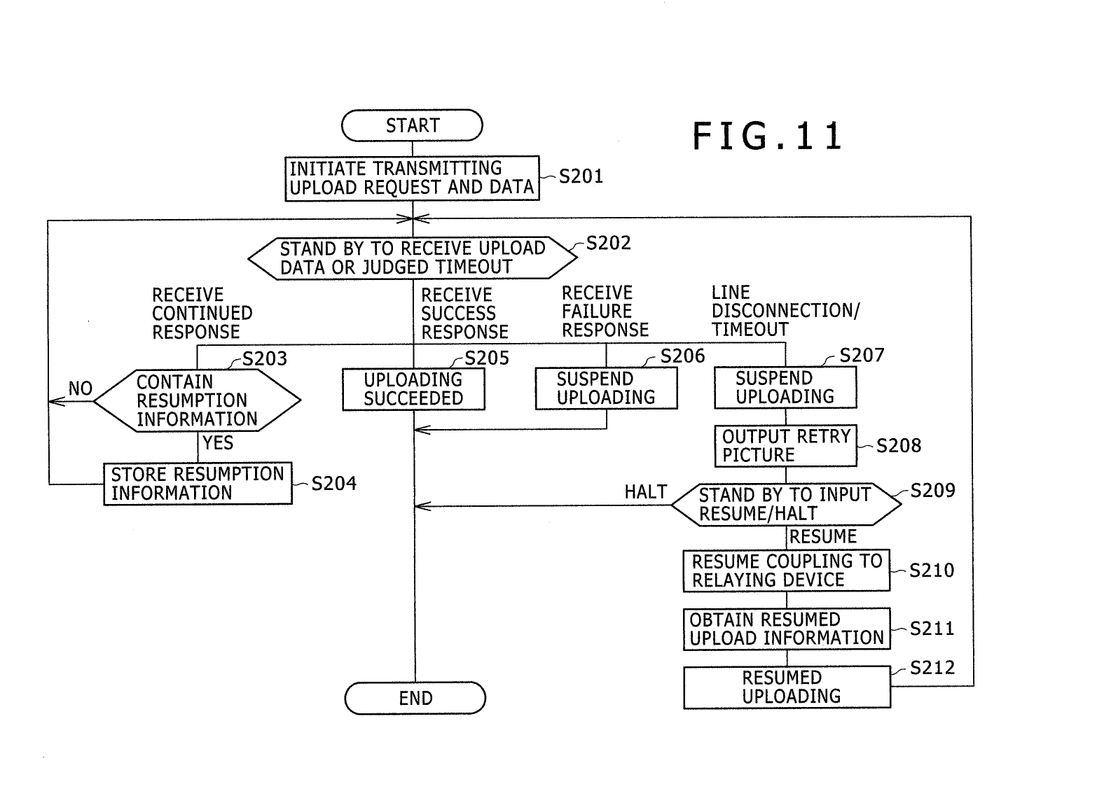

With reference to FIG. 11, the procedural flow of the mobile phone is explained as follows. FIG. 11 shows a flow chart of the uploading steps. As shown, in the first place, the mobile phone 1 begins transmitting an upload request and data to the relaying device 4 at S201. Unless an uploading suspension step at S206 or S207 is taken during the uploading operation initiated at S201, the mobile phone continues transmitting the upload data to the relaying device 4. The mobile phone 1 stands by to receive an upload data at S202 and receives a continued response from the relaying device 4. The mobile phone 1 judges whether a piece of resumption information 136 is contained in the continued response at S203 and stores such response when such information is contained therein at S 204. The mobile phone 1 operational step returns from S203 or S204 to S202 to stand by to receive an upload data.

The mobile phone 1 suspends uploading at S207 when line disconnection occurs or it does not receive a response from the relaying device 4 during the uploading operation so that it is judged timeout. The mobile phone 1 outputs a picture for retry on the graphical interface 14 at S208. The mobile phone 1 waits for the user choosing to resume or halt uploading at S209 and finish uploading if he/she chooses to halt. If the user chooses to resume, the mobile phone 1 resumes coupling to the relaying device 4 by use of a relaying device address 138 of the resumption information 136 so as to transmit a message ID 101 at S210. The mobile phone 1 obtains a piece of resumed upload information 172 from the relaying device 4 at S211 and resumes uploading at S212, at which the mobile phone 1 confirms a size of the upload data, which the relaying device 4 has received up to line disconnection 160, based on a received data size 104 or a segmental option 106 contained in the piece of resumed upload information 172 as received and transmits such data as the relaying device 4 having not received yet as an upload data. Subsequent to S212, the mobile phone operational step returns to S202, in which the mobile phone judges that the uploading operation has succeeded at S205 when receiving a success response from the relaying device 4 so as to normally end.

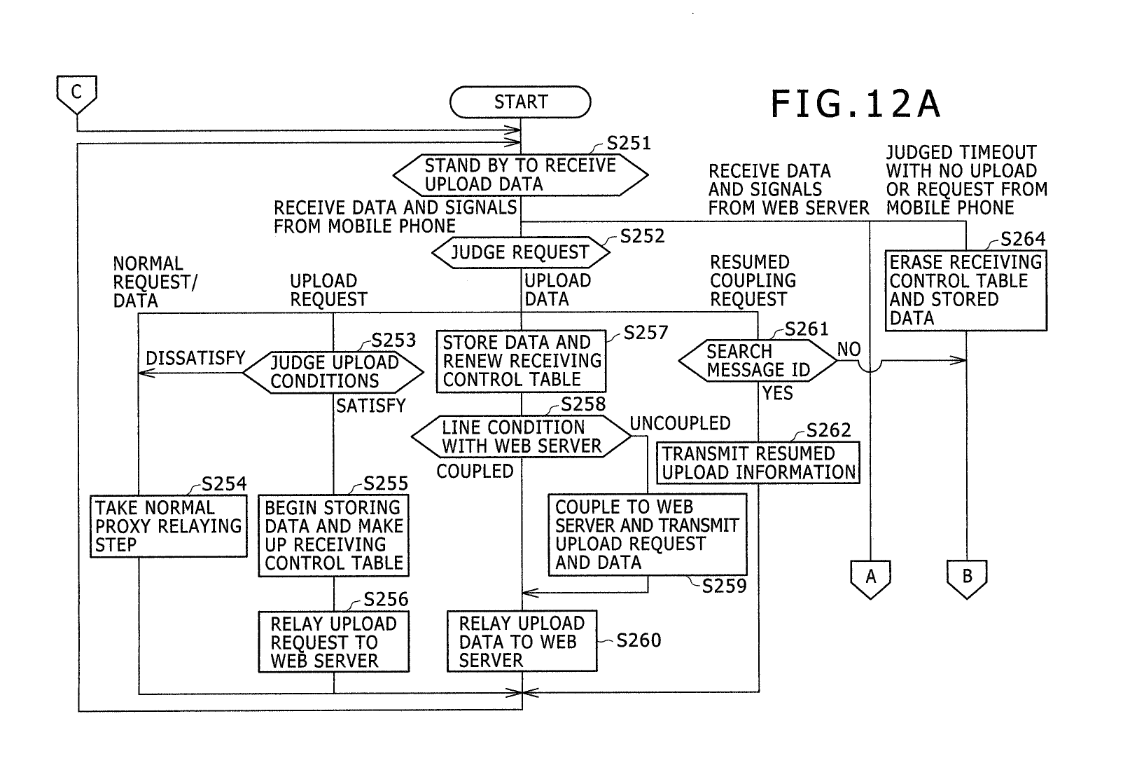

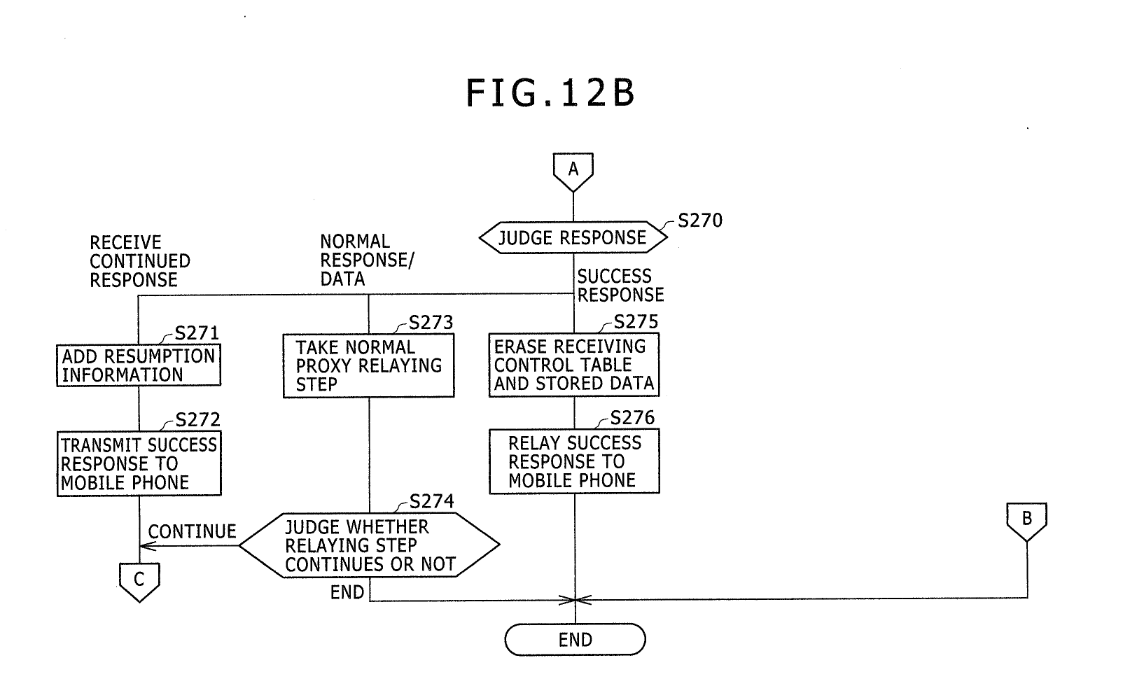

With reference to FIG. 12, the operational flow of the relaying device is explained as follows. FIG. 12 is a flow chart showing the uploading steps of the relaying device. As shown in FIG. 12A, upon the execution of the programs of the relaying device 4 starting, the relaying device 4 stands by to receive an upload data from the input and output circuit interface 45 at S251, at which the relaying device 4 monitors an upload data and signals input from the input and output circuit interface 45 so as to judge whether they are received from the mobile phone 1 or the web server 6. Further, at S251, the relaying device 4 refers to the last data received time 107 of the receiving control table 43 while not receiving any upload data, and judges whether the corresponding message (stored data) is rendered timeout or not.

The relaying device 4 judges a request at S252 upon receiving data from the mobile phone 1. The relaying device 4 judges whether such request is an upload request (POST or PUT request) or an upload data or a resumed coupling request for the resumption of uploading or a normal request/data other than the foregoing. At S252, it being found as an upload request, the relaying device 4 judges whether such request satisfies upload judge conditions at S253, at which the relaying device 4 makes a judgment on whether it stores the upload request or takes a normal proxy relaying step. Those conditions are met hereby when a size of the upload data has gone beyond a predetermined value. At S253, when it is judged as not satisfying them, the relaying device 4 takes a normal proxy relaying step at S254 and its operational step returns to S251. If it is judged as satisfying them at S253, the relaying device 4 begins storing the upload data and makes up the receiving control table 43 at S255 as well as forwarding the upload request to the web server 6 at S256. The relaying device 4 operational step, subsequent to S256, returns to S251.

As shown in FIG. 12B, upon receiving data from the web server 6, the relaying device 4 makes a response judgment at S270, at which the relaying device 4 judges whether it is a continued response or a success response or a line disconnection from the web server 6 or a normal response/data other than the foregoing. Upon receiving the continued response, the relaying device 4 adds a piece of resumption information 236 thereto at S271 for transmit to the mobile phone 1 at S272. The relaying device 4 operational step, subsequent to S272, returns to S251.

At S252 of FIG. 12A, when the relaying device 4 has received from the mobile phone 1 an upload request data whose receiving control table 43 is made up, it stores the upload data and renews the received data size 104 and the last data received time 107 of the receiving control table at S257. The relaying device 4, subsequent to S257, judges line condition with the web server 6 at S258 and relays the upload data to the web server 6 at S260 if they are judged coupled. The relaying device 4 operational step, subsequent to S260, returns to S251. If they are judged uncoupled at S258, the relaying device 4 operational step proceeds to S260 after it is coupled to the web server 6 to transmit the upload request data thereto at S259.

Even if line disconnection occurs between the mobile phone 1 and the relaying device 4, the latter keeps the stored data for a certain time from the last data received time 107 of the receiving control table 43. However, unless there is an upload data or a resumed coupling request 170 from the mobile phone 1 for a certain while from the time 107, it is judged timeout at S264 so that the relaying device erases the receiving control table 43 and the stored data to end its operational step.

Upon receiving a resumed coupling request from the mobile phone 1 at S252, the relaying device 4 searches a message ID 102 contained in such request from the receiving control table 43 at S261 and ends its operational step if there is not found such message ID. At S261, if there is found the corresponding message ID, the relaying device 4 transmits a piece of resumed upload information including a received data size 104 or a segmental option 106 to the mobile phone 1 at S262. The relaying device 4 operational step, subsequent to S262, returns to S251.

Upon the relaying device 4 receiving a success response from the web server 6 at S270 of FIG. 12B, it judges that the uploading operation from the mobile phone 1 has succeeded so as to erase the receiving control table and the stored data at S275 as well as to transmit the success response to the mobile phone 1 at S276 to end its operational step.

Where the relaying device 4 has received a non-corresponding response in the receiving control table 43 from the web server 6 at S270, it takes a normal proxy relaying step at S273 and judges whether or not to continue the relaying step at S274, so that it stepwise returns to S251 for standing by to receive data if that is the case while ends its operational step if that is to the contrary.

According to the first embodiments, where line disconnection occurs during uploading data from the mobile phone to the web server, they enable the uploading operation to be resumed without need to retransmit the data having been transmitted once from the mobile phone. They are also applicable to a workload sharing system.

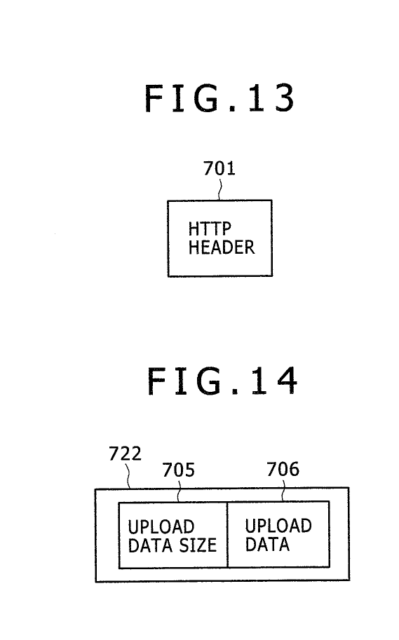

The modified embodiment is described with reference to FIGS. 13 and 14. FIG. 13 shows an upload request format by use of ‘Transfer-Encoding: chunked’ in compliance with HTTP1.1 while FIG. 14 shows an uploading data format of segmental transmission.

As shown in FIG. 13, the uploading request format only includes an HTTP header 701, in which header a transmission size (Content-length) is not contained.

As shown in FIG. 14, the upload data includes an HTTP header not shown therein and an HTTP body 722, which body includes an upload data size 705 and the upload data 706. The last HTTP body 722 of segmentally transmitted upload data has ‘0’ in the size 705 and only newlines (data showing ‘emptiness’) in the upload data 706.

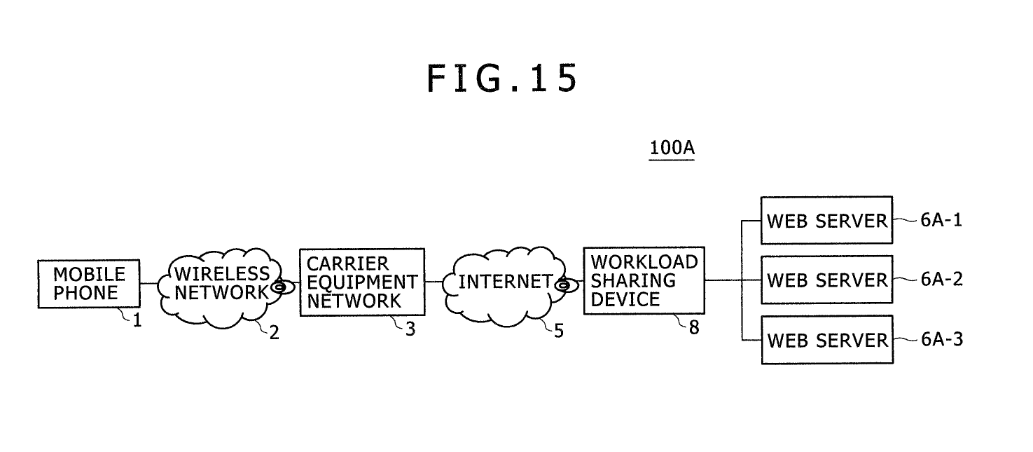

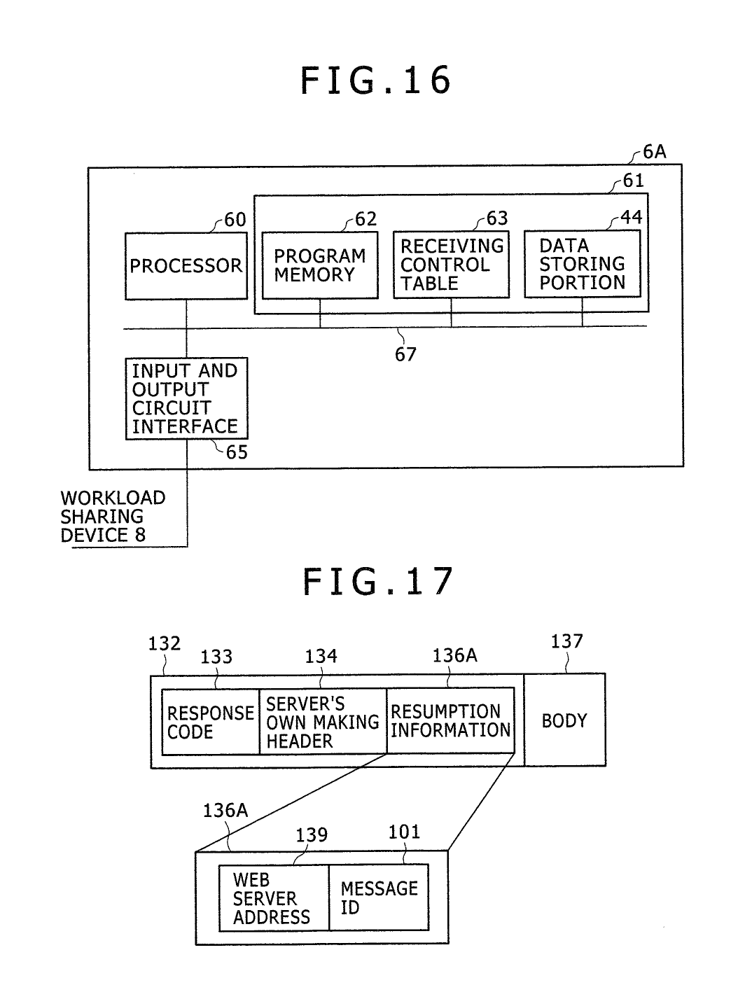

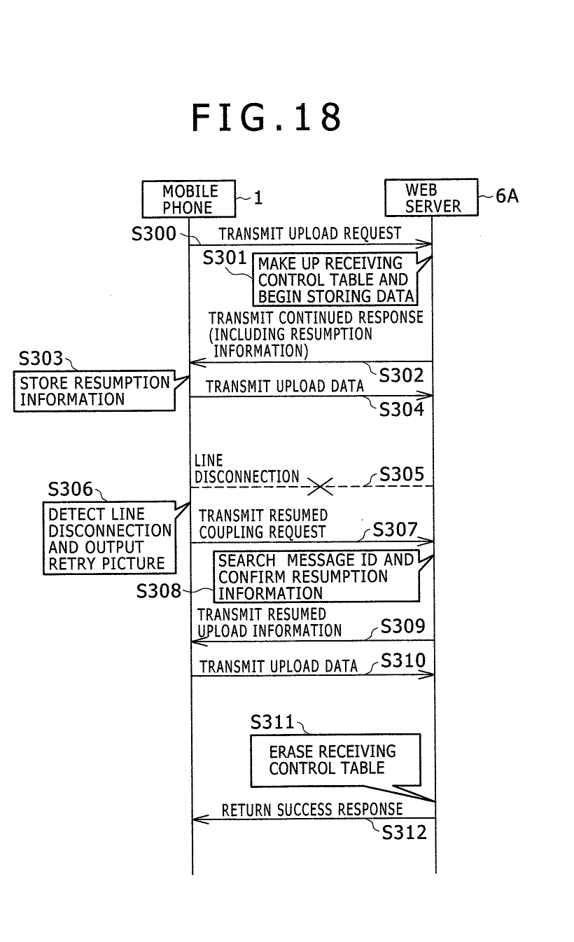

The second embodiment according to the invention is explained with reference to FIGS. 15 through 18. FIG. 15 shows a block diagram of the network system. FIG. 16 shows a hardware block diagram of the web server. FIG. 17 shows a message format of a continued response. FIG. 18 shows a sequential diagram of the upload data between the mobile phone and the web server.

The second embodiment is characterized in making the web server 6A instead of the relaying device 4 according to the first embodiment keep the function to resume uploading and gaining the same effect as the first embodiment. The difference between those embodiments is explained with reference to FIG. 15 through FIG. 18. FIG. 15 shows a block diagram of the network system. FIG. 16 shows a hardware block diagram of the web server. FIG. 17 shows a message format of a continued response. FIG. 18 shows a sequential diagram of the upload data between the mobile phone and the web server.

As shown in FIG. 15, the network system 100A includes a mobile phone 1, a wireless network 2, a carrier equipment network 3, the Internet 5, a workload sharing device 8 and a plurality of web servers. The mobile phone 1, through the wireless network 2, the carrier equipment network 3, the Internet 5 and the workload sharing device 8, makes a direct communication with the respective web servers 6A. To note, the workload is shared among three web servers 6A by the workload sharing device 8 according to the second embodiment. Each of the web servers 6A has an address (hereinafter, referred to as a web server address) through which the mobile phone 1 is able to couple to one of those web servers 6A-1 through 6A-3. The web server address is an identifiable address enabling the mobile phone 1 to directly access the web server 6A, the examples of which include an IP address, a host name, a URL or Cookie information. The Cookie information may be used in such a manner that the workload sharing device distributing the workload among the web servers 6A judges the same information so as to make the mobile phone couple to the specific web server.

With reference to FIG. 16, an information processing device realizing the web server 6A is explained as follows. As shown, the web server 6A includes a processor 60, a memory storage 61, an input and output circuit interface 65 to make data received in the workload sharing device 8 and transmitted thereto and an internal communication line 67 such as a bus to couple those means. The memory storage 61 stores a program memory 62, a receiving control table 63 and a data storing portion 64. Various kinds of controlling programs to realize the web server 6A are recorded in the program memory 62, which memory is executed by the processor 60. To note, the respective programs may be preliminarily stored in the program memory 62 or be introduced therein through a detachable storage medium or communication medium (network or carrier wave propagating the same) not shown in the drawing. Information to control the upload request and data that the web server 6A has received from the mobile phone 1 is described in the receiving control table 63, which table may be made up when the web server 6A relays the upload request from the mobile phone 1 or the web server 6A may obtain and incorporate from a storage medium having a receiving control table other than the web server 6A through a communication medium (network or carrier wave propagating the same). In the data storing portion 64, information obtained when the web server 6A relays its HTTP message to the mobile phone 1 and that used for resumption subsequent to line disconnection between the mobile phone 1 and the web server 6A are stored. The memory storage 61 is a semiconductor storage or an external memory storage such as a hard disk. The web server 6A is provided with an input device and a display to enable the system administrator to input data therein, neither of which is used in the following explanation so that they are omitted in FIG. 16.

With reference to FIG. 17, a continued response that the web server 6A transmits to the mobile phone 1 and to which a piece of resumption information is added is explained as follows. The difference with the first embodiment lies in the fact that there is no proxy additional header 135 and a web server address 139 accessible to the web server 6A on behalf of the relaying device address 138 is contained in a piece of resumption information 136A.

With reference to FIG. 18, the uploading sequential steps between the mobile phone and the web server are explained as follows. As shown, in the first place, the mobile phone 1 transmits an upload request to the web server 6A at S300. The web server 6A stores a Subscriber ID contained in the HTTP header of the upload request and makes up a receiving control table 43 so as to begin receiving the upload request 330 and the upload data at S301. The web server 6A transmits a continued response by a response code 100 in compliance with HTTP to the mobile phone 1 at S302. The mobile phone 1 stores a piece of resumption information 136 contained in the continued response at S303 and transmits the upload data at S304.

Assuming that line disconnection between the mobile phone 1 and the web server 6A has occurred during the uploading operation at S305, the mobile phone 1 detects such line disconnection and suspends uploading as well as outputs a picture for retry on a picture output interface 16 at S306. The user of the mobile phone 1 is able to choose whether or not to retry on the picture. Assuming the user has chosen to retry, the mobile phone 1, by use of the resumption information 136, transmits a resumed coupling request to the web server 6A that has transmitted such information at S307. Upon receiving the resumed coupling request 307, the web server 6A, by use of a message ID 101 contained in such request, extracts and confirms items corresponding to the receiving control table 63 at S308. The web server 6A transmits to the mobile phone 1 a piece of resumed upload information corresponding to the response containing a piece of information on a received data size 104 of the receiving control table 63 and complying with HTTP at S309. The mobile phone 1 confirms a size of the upload data that the web server 6A has received prior to line disconnection 305 based on the received data size 104 contained in the resumed upload information as received so as to transmit data that the web server has not received yet as the upload data at S310. The web server 6A resumes receiving the remaining upload data from the state prior to the line disconnection and transmits a success response to the mobile phone 1 at S312 with the corresponding receiving control table 63 erased at S311 upon receiving the whole upload data. The mobile phone 1, upon receiving the success response, judges that the uploading operation has succeeded so as to end the same.

According to the present embodiment, where line disconnection has occurred during the data uploading operation from the mobile phone to the web server, the resumption of such operation is realized without need to retransmit the data having been transmitted once from the mobile phone, and the present embodiment is applicable to a workload sharing system.

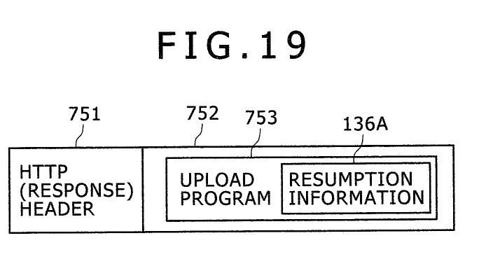

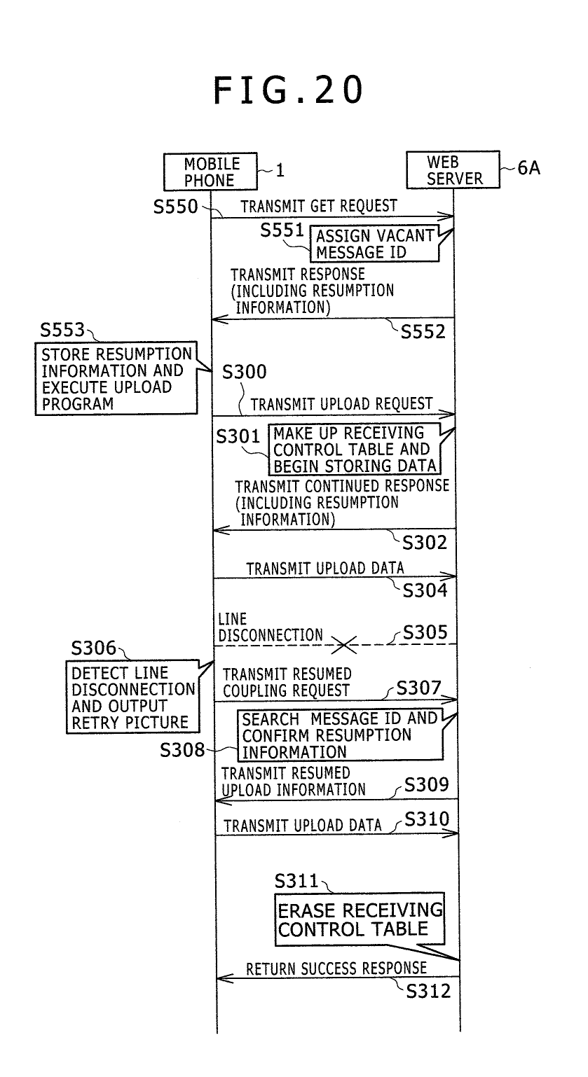

With reference to FIGS. 19 and 20, the third embodiment of the present invention is explained as follows. The present embodiment is characterized in that on behalf of storing a piece of resumption information in the continued response, which is characteristic in the second embodiment, a message in compliance with HTTP is exchanged between the mobile phone 1 and the relaying device 4 or the web server 6A so as to result in the same effect as the second embodiment. The difference between the second and third embodiments is explained with reference to FIGS. 19 and 20. FIG. 19 shows a message format of a response against a GET request. FIG. 20 shows a sequential diagram of the uploading operation effected between the mobile phone and the web server.

As shown in FIG. 19, the response transmitted from the web server 6A to the mobile phone 1 with the addition of a piece of resumption information against the GET response includes an HTTP header (response) 751 and an HTTP body 752, in which body an upload program 753 is stored. Further, a piece of resumption information 136A is embedded with the upload program 753.

With reference to FIG. 20, the sequential steps of the uploading operation between the mobile phone 1 and the web server 6A is explained as follows. As shown in FIG. 20, in the first place, the mobile phone 1 transmits a normal GET request in compliance with HTTP to the web server 6A at S550. The web server 6A assigns a vacant message ID 101 in the receiving control table 43 to the mobile phone 1 at S551 and transmits thereto a normal success response with the addition of the upload program embedded with the resumption information to the HTTP body 752 at S552. In the third embodiment, the web server 6A controls the massage ID 101 for each line and is able to assign the same to the mobile phone before receiving an upload request 300 at S551. In the resumption information 136, as shown in FIG. 19, an upload program 753 to operate on a program (web browser) through which the mobile phone executes an HTTP communication is included. Further, in the upload program 753, a piece of resumption information 136A comprising a web server address 139 and a message ID is incorporated. The mobile phone 1, upon receiving the response, executes the upload program 753 and stores the resumption information at S553. In the upload program 753, the operational steps of the mobile phone 1 from S552 through the step of receiving a success response 312 are described. The mobile phone 1 transmits an upload request according to the upload program 753 at S300 and operates in the same way as shown in FIG. 18 according to the second embodiment up to receiving the success response at S312. To note, what it does not matter hereby whether a piece of resumption information is included in a continued response differs from the second embodiment.

According to the third embodiment, where line disconnection has occurred during the data uploading operation from the mobile phone to the web server, the resumption of such operation is realized without need to retransmit the data having been transmitted once from the mobile phone, and the present embodiment is applicable to a workload sharing system.

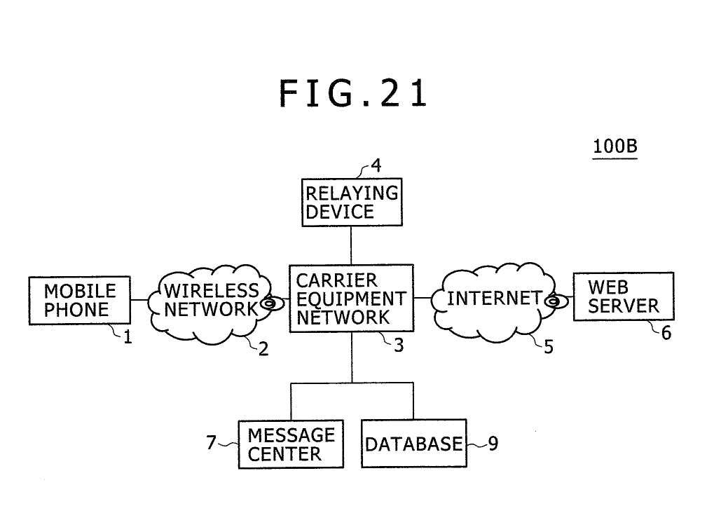

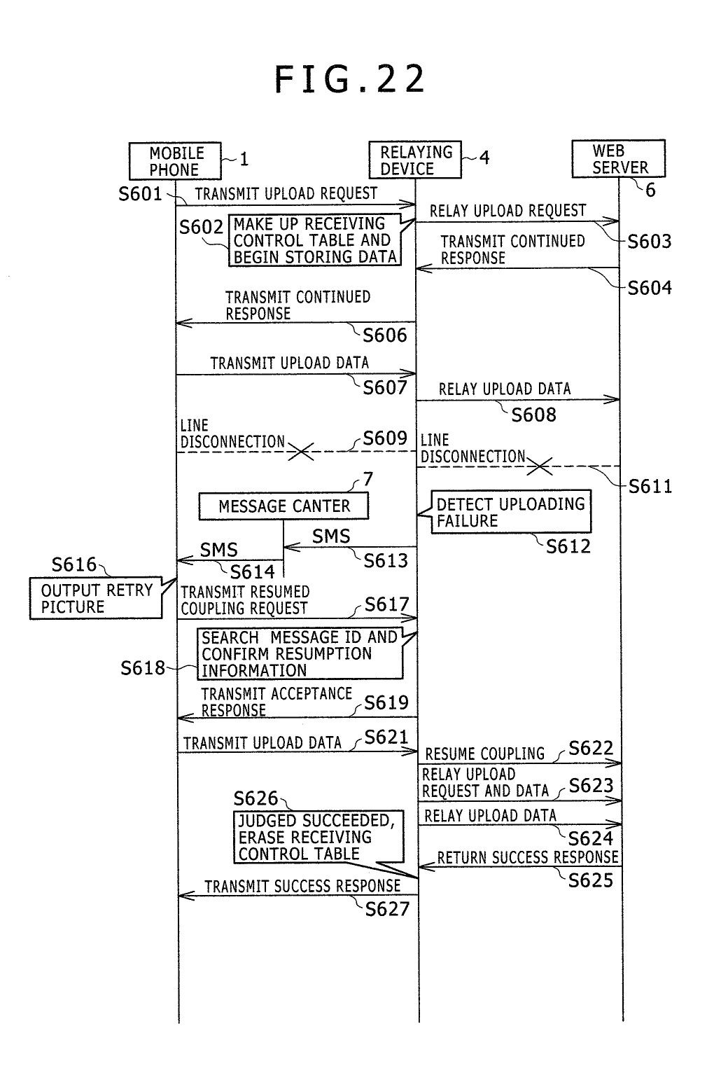

With reference to FIGS. 21 and 22, the fourth embodiment according to the invention is explained as follows FIG. 21 shows a block diagram of the network system. FIG. 22 shows sequential steps of the data uploading operation among the mobile phone, the relaying device, the web server, and a message center. The fourth embodiment is characterized in that on behalf of storing a piece of resumption information in the continued response according to the first embodiment, the relaying device transmits a short message to the mobile phone subsequent to line disconnection. The same effect as the first embodiment is achieved by incorporating a relaying device address, a message ID and a received data size in this short message. The difference between those embodiments is explained as follows with reference to FIGS. 21 and 22.

As shown in FIG. 21, the network system 100B includes a mobile phone 1, a wireless network 2, a carrier equipment network 3, a relaying device 4 coupled to the carrier equipment network 3, a message center 7, a database 9, the Internet 5 and a web server 6. The message center 7 transmits a short message to the mobile phone 1. The database 9 makes a SUBSCREIBER ID correspond to an SMS address (telephone number).

As shown in FIG. 22, in the first place, the mobile phone 1 transmits an upload request to the web server 6 at S601. In actual, the relaying device 4 receives and analyzes such request, and stores a SUBSCREIBER ID contained in the HTTP header of such request as well as makes up a receiving control table 43 and begins storing an upload data at S602, provided that such request satisfies uploading judge conditions.

The relaying device 4 relays the upload request to the web server 6 at S603 and receives a continued response by a response code 100 in compliance with HTTP from the web server 6 at S604. The continued response is that indicating that the upload data is receivable in the web server 6. The relaying device 4, differently from the first embodiment, takes a normal relaying proxy step for the continued response as received and transmits the same as it is to the mobile phone 1 at S606.

The mobile phone 1 continues uploading the data at S607. The relaying device 4 stores the upload data and relays the same to the web server 6 at S608. It does not matter whether the whole data size of the upload data as received by the relaying device 4 is relayed to the web server 6 or such data is relayed thereto each time the former receives the same.

Assuming that line disconnection between the mobile phone 1 and the relaying device 4 has occurred during the uploading operation at S609 and the line between the relaying device 4 and the web server 6 has been uncoupled by timeout at S611, the relaying device 4 detects an uploading failure at S612 and makes up a short message (hereinafter, referred to as ‘SMS’) addressed to the mobile phone 1 by use of a SUBSCREIBER ID 102 of the receiving control table 43 at S613. The SUBSCREIBER ID 102 is an identifier to identifiably distinguish the mobile phone 1, which identifier the relaying device 4 stores in the SMS for transmission to the mobile phone 1. However, it is a message center 7 disposed in the carrier equipment network 3 that allots the SMS, to which center the relaying device 4 transmits the SMS. A relaying device address, a message ID 101 and a received data size 104 are stored in the SMS prepared by the relaying device 4. The message center 7 forwards to the mobile phone 1 the SMS received from the relaying device 4 at S614.

The mobile phone 1, upon receiving the SMS from the message center 7, outputs a retry picture at S616. The user of the mobile phone 1 may choose whether or not to retry on the retry picture and chooses retrying. The mobile phone 1 transmits to the relaying device address as stored in the SMS a resumed coupling request with the message ID 101 attached therein at S617. According to the type of the SMS prepared by the relaying device 4, the mobile phone 1 may be arranged such that it automatically transmits a resumed coupling request without consent by the user on the retry picture.

The relaying device 4, upon receiving a resumed coupling request, by use of the message ID 101 contained therein, extracts and confirms items corresponding to the receiving control table 43 at S618 and transmits an acceptance response to accept such request at S619.

The mobile phone 1, upon receiving the acceptance response, confirms a size of the upload data that the relaying device 4 has received prior to line disconnection based on a received data size 104 of the receiving control table 43 as contained in the SMS and transmits data that the relaying device 4 has not received yet as the upload data at S621. The relaying device 4, upon the mobile phone 1 resuming uploading, resumes coupling to the web server 6 at S622. The relaying device 4 transmits the upload request and data stored therein to the web server at S623. To note, upon the web server 6 receiving the upload request and data, it returns a continued response, which is omitted hereby to facilitate a series of operational steps. The relaying device 4 that has received a new upload data transmits the same to the web server 6 at S624. Upon the whole upload data being transmitted from the mobile phone 1 to the web server 6, the web server 6 returns a success response at S625. Upon receiving the success response, the relaying device 4 discerns that the uploading operation has succeeded so as to erase the corresponding items of the receiving control table 43 and the stored data at S626 and transmits the success response to the mobile phone 1 at S627. Upon receiving the success response, the mobile phone 1 discerns that the uploading operation has succeeded so as to end the uploading operation.

To note, the relaying device 4 may query the SUBSCREIBER ID 102 of the mobile phone 1 to the database 9 disposed in the carrier equipment network 3 so as to obtain an address (telephone number) of the SMS and transmits the same to the message center. Further, in the arrangement of the network system 100A according to the second or third embodiment, the short message may be transmitted from the web server 6 through the message center 7 to the mobile phone 1. Moreover, like the first embodiment, the plurality of relaying devices 4 may be disposed, by which workload is shared among them.

According to the present embodiment, where line disconnection has occurred during the data uploading operation from the mobile phone to the web server, the resumption of such operation is realized without need to retransmit the data having been transmitted once from the mobile phone.

The specification and drawings are, accordingly, to be regarded in an illustrative rather than a restrictive sense. It will, however, be evident that various modifications and changes may be made thereto without departing from the spirit and scope of the invention as set forth in the claims.

We claim:

1. A communication device provided with a processor, a memory storage and an input and output interface that are coupled through an internal communication line, wherein the processor executes a program stored in the memory storage, wherein the input and output interface is coupled to a client device through a first network, and wherein the processor acts as a memory controller to store into the memory storage an upload request together with a communication identifier upon receiving the upload request from the client device while to store an upload data into the memory storage upon receiving the upload data from the client device and as a transmission controller to transmit to the client device the communication identifier along with an address of the communication device in response to the upload request while to transmit to the client device the communication identifier together with a size of the upload data as stored in the memory storage in response to a resumed coupling request from the client device upon receiving the resumed coupling request therefrom.

2. A communication device provided with a processor, a memory storage and an input and output interface that are coupled through an internal communication line, wherein the processor executes a program stored in the memory storage, wherein the input and output interface is coupled to a client device through a first network, and wherein the processor acts as a memory controller to store into the memory storage an upload request together with a communication identifier upon receiving the upload request from the client device while to store an upload data into the memory storage upon receiving the upload data from the client device and as a transmission controller to transmit to the client device the communication identifier, a size of the upload data as stored in the memory storage together with an address of the communication device upon detecting that a line is disconnected from the client device.

3. A communication device according to claim 1, wherein the input and output interface is further coupled to a server through a second network, and wherein the transmission controller transmits to the server the upload request and the upload data as stored in the memory storage upon receiving the resumed coupling request from the client device.

4. A communication device according to claim 3, wherein the transmission controller transmits to the server a new upload data upon receiving the new upload data from the client device.

5. A communication device according to claim 1, wherein the memory controller destroys the upload request and the upload data as stored in the memory storage upon detecting that an uploading operation from the client device is over.

6. A communication device according to claim 1, wherein the transmission controller transmits to the client device an upload program incorporating a piece of resumption information upon receiving the resumed coupling request from the client device.

7. client device provided with a processor, a memory storage, an input and output interface, a picture output interface and an input interface that are coupled through an internal communication line, wherein the processor executes a program stored in the memory storage, wherein the input and output interface is coupled to a communication device through a network, and wherein the processor acts as a memory controller to store in the memory storage a communication identifier and an address of the communication device as contained in a response against an upload request transmitted to the communication device and as a transmission controller to transmit to the address a resumed coupling request containing the communication identifier upon an uploading operation to the communication device being suspended.

8. A client device according to claim 7, further comprising a picture output interface and an input interface, wherein the client device is arranged such that a prompting indication to input whether to transmit or not the resumed coupling request through the input interface is displayed in the picture output interface upon an uploading operation to the communication device being suspended.

9. A client device according to claim 7, wherein the transmission controller transmits to the address an upload data subsequent to a received data size of the communication device contained in a response against the resumed coupling request.
